(19) United States
(12) Patent Application Publication
(10) Pub. No.: US 2015/0029163 A1
(43) Pub. Date: Jan. 29, 2015

(54) STYLUS HAVING A DEFORMABLE TIP AND METHOD OF USING THE SAME

(71) Applicant: FiftyThree, Inc., New York, NY (US)

(72) Inventors: Jonathan R. Harris, Redmond, WA (US); John K. Ikeda, Seattle, WA (US); Audrey Louchart, Seattle, WA (US)

(73) Assignee: FiftyThree, Inc., New York, NY (US)

(21) Appl. No.: 14/340,345

(22) Filed: Jul. 24, 2014

Related U.S. Application Data
(60) Provisional application No. 61/857,812, filed on Jul. 24, 2013.

(51) Int. Cl. G06F 3/0354

(52) U.S. Cl. CPC G06F 3/03545
USPC 345/179

(57) ABSTRACT

A stylus has a body portion and a tip portion coupled to an end of the body portion. The body portion defines a first cross-sectional area and is configured to be engaged by a user. The tip portion has a first end disposed adjacent to the body portion and having the first cross-sectional area, and a second end defining a second cross-sectional area different from the first cross-sectional area. The tip portion is formed from a flexible material that elastically deforms when placed in contact with a touch sensitive display to define an engagement surface that is input to the touch sensitive display. The engagement surface has a first size when the stylus is in a first configuration and a second size different from the first size when the stylus is in a second configuration.

### CROSS-REFERENCE TO RELATED APPLICATIONS

This application claims priority to and the benefit of U.S. Provisional Patent Application Ser. Nos. 61/857,812 entitled, “Stylus Having a Deformable Tip and Methods of Using the Same,” filed Jul. 24, 2013, the disclosure of which is incorporated herein by reference in its entirety.

This application is also related to co-pending U.S. Patent Application having Attorney Docket No. FIFT-008/02US 317784-2028, filed on the same date, and entitled “Methods and Apparatus for Implementing Dual Tip Functionality in a Stylus Device,” and U.S. Patent Application having Attorney Docket No. FIFT-009/O1US 317784-2030, filed on the same date, and entitled “Methods and Apparatus for Providing Universal Stylus Device with Multiple Functionalities,” each of which is incorporated herein by reference in its entirety.

### BACKGROUND

Embodiments described herein relate generally to styluses, and more particularly, to styluses having a deformable tip.

Producing text and/or drawings by hand onto a medium such as paper or canvas is well known. Some utensils used to produce the text and/or drawings on the medium can be associated with specific characteristics. For example, drawing with the tip of a sharpened lead pencil can produce a relatively thin line on the medium, while holding the pencil at an angle and drawing with the side of the sharpened lead pencil can produce a relatively thick line on the medium. Moreover, the pressure that is applied to the medium by the writing surface of the utensil (e.g., as applied by the user of the utensil) can also be associated with specific characteristics. For example, the darkness of a line can be increased as the pressure applied on the medium by the writing surface of the utensil increases.

The advent of electronic devices such as personal computers (PCs), smart phones, and tablet PCs has produced a shift towards digital art and/or writing. In some instances, a user of the electronic device can interact with interfaces such as, for example, a keyboard, a mouse, a touch screen (either with a stylus or finger) to produce text or a drawing. Such interfaces, however, often lack the haptic sensations and/or the desired effects as one might expect from a utensil on a medium (e.g., paper or canvas). For example, in some instances, the pressure exerted on a touch screen by a stylus may not change the darkness of a line.

Thus, a need exists for improved apparatus such as a stylus that more closely replicates the user experience of producing text and/or drawing by hand onto a medium such as paper or canvas.

### SUMMARY

Apparatus and methods for a stylus having a deformable tip are described herein. In some embodiments, an apparatus includes a stylus having a body portion and a tip portion. The body portion defines a first cross-sectional area and is configured to be engaged by a user. The tip portion is coupled to an end of the body portion and includes first end and a second end. The first end is disposed adjacent to the body portion and has the first cross-sectional area. The second end defines a second cross-sectional area different from the first cross-sectional area. The tip portion is formed from a flexible material that elastically deforms when placed in contact with a touch sensitive display to define an engagement surface that is input to the touch sensitive display. The engagement surface has a first size when the tip portion is placed in contact with the touch sensitive display and the stylus is in a first configuration and a second size different from the first size when the tip portion is placed in contact with the touch sensitive display and the stylus is in a second configuration.

### BRIEF DESCRIPTION OF THE DRAWINGS

FIG. 1 is a schematic illustration of a stylus, according to an embodiment.

FIGS. 2 and 3 are a side view and a front view, respectively, of a stylus according to an embodiment.

FIGS. 4 and 5 are a front view and a perspective view, respectively, of a tip portion of the stylus of FIG. 2 illustrating an exemplary engagement surface.

FIGS. 6 and 7 are a front view and a perspective view, respectively, of the tip portion of the stylus of FIG. 2 illustrating an exemplary engagement surface.

FIG. 8 illustrates an increase in area of an engagement surface as a result of changing the orientation of the stylus of FIG. 2 relative to a surface.

FIGS. 9-12 are various views of the stylus of FIG. 2 being used in various configurations.

FIG. 13 is a side, front, and top view of an end portion of the stylus of FIG. 2.

FIG. 14 is a front view of a stylus, according to another embodiment.

FIG. 15 is perspective view of the stylus of FIG. 14 coupled to an electronic device.

FIGS. 16-18 are various views of a tip portion of a stylus, each according to a specific embodiment.

### DETAILED DESCRIPTION

Embodiments for a stylus having a deformable tip are described herein. In some embodiments, an apparatus includes a stylus having a body portion and a tip portion. The body portion defines a first cross-sectional area and is configured to be engaged by a user. The tip portion is coupled to an end of the body portion and includes first end and a second end. The first end is disposed adjacent to the body portion and has the first cross-sectional area. The second end defines a second cross-sectional area different from the first cross-sectional area. The tip portion is formed from a flexible material that elastically deforms when placed in contact with a touch sensitive display to define an engagement surface that is input to the touch sensitive display. The engagement surface has a first size when the tip portion is placed in contact with the touch sensitive display and the stylus is in a first configuration and a second size different from the first size when the tip portion is placed in contact with the touch sensitive display and the stylus is in a second configuration.

In some embodiments, an apparatus includes a stylus having a body portion configured to be engaged by a user and a tip portion coupled to an end of the body portion. The body portion has a first cross-sectional shape. The first cross-sectional shape has a thickness and a width different from the thickness. The tip portion has a first end having the first cross-sectional shape and a second end having a second cross-sectional shape. The second cross-sectional shape having a size smaller than a size of the first cross-sectional shape. The tip portion includes a first surface and a second surface extending between the first end and the second end. The first surface is associated with the thickness while the second surface is associated with the width. The tip portion is formed from a flexible material configured to elastically deform when placed in contact with a touch sensitive display to define an engagement surface that is input to the touch sensitive display. The engagement surface has a first size when the first surface of the tip portion is placed in contact with the touch sensitive display and a second size different from the first size when the second surface of the tip portion is placed in contact with the touch sensitive display.

In some embodiments, a method includes deforming a tip portion of a stylus a first amount such that a first engagement surface of the tip portion is in contact with a touch sensitive display and that is input to the touch sensitive display. The first amount of deformation is associated with the stylus in a first configuration and the first engagement surface has a first size associated with the stylus in the first configuration. The method includes deforming the tip portion of the stylus a second amount such that a second engagement surface of the tip portion is in contact with the touch sensitive display and that is input to the touch sensitive display. The second amount of deformation is associated with the stylus in a second configuration different from the first configuration. The second engagement surface has a second size different from the first size and associated with the stylus in the second configuration.

In some embodiments, a stylus includes a tip portion and a body portion. The tip portion has an engagement surface that is substantially deformable. The body portion of the stylus is configured to be engaged to orient the stylus to selectively place the engagement surface of the tip portion in contact with a touch screen of an electronic device.

As used in this specification, the singular forms “a,” “an” and “the” include plural referents unless the context clearly dictates otherwise. Thus, for example, the term “an engagement surface” is intended to mean a single surface or multiple surfaces unless explicitly expressed otherwise.

As used herein, the terms “about” and “approximately” generally mean plus or minus 10% of the value stated. For example, about 0.5 would include 0.45 and 0.55, about 10 would include 9 to 11, about 1000 would include 900 to 1100.

As used herein, the term “stiffness” is related to an object's resistance to deflection, deformation, and/or displacement that is produced by an applied force, and is generally understood to be the opposite of the object's “flexibility.” For example, a wall with greater stiffness is more resistant to deflection, deformation and/or displacement when exposed to a force than a wall having a lower stiffness. Similarly stated, an object having a higher stiffness can be characterized as being more rigid than an object having a lower stiffness. Stiffness can be characterized in terms of the amount of force applied to the object and the resulting distance through which a first portion of the object deflects, deforms, and/or displaces with respect to a second portion of the object. When characterizing the stiffness of an object, the deflected distance may be measured as the deflection of a portion of the object different from the portion of the object to which the force is directly applied. Said another way, in some objects, the point of deflection is distinct from the point where force is applied.

Stiffness (and therefore, flexibility) is an extensive property of the object being described, and thus is dependent upon the material from which the object is formed as well as certain physical characteristics of the object (e.g., cross-sectional shape, length, boundary conditions, etc.). For example, the stiffness of an object can be increased or decreased by selectively including in the object a material having a desired modulus of elasticity, flexural modulus and/or hardness. The modulus of elasticity is an intensive property of (i.e., is intrinsic to) the constituent material and describes an object's tendency to elastically (i.e., non-permanently) deform in response to an applied force. A material having a high modulus of elasticity will not deflect as much as a material having a low modulus of elasticity in the presence of an equally applied stress. Thus, the stiffness of the object can be decreased, for example, by introducing into the object and/or constructing the object of a material having a relatively low modulus of elasticity.

Similarly, a material's hardness is an intensive property of the constituent material and describes the measure of how resistant the material is to various kinds of permanent shape change when a force is applied. In discussing the hardness and the subsequent effect on the stiffness of an object, the Shore durometer scale is often used. There are several scales for durometers two of which are commonly used in describing plastics, polymers, elastomers, and/or rubbers, namely, type A and type D, where type A is generally used for softer materials and type D is generally used for harder materials. The Shore durometer of a material is denoted by a number between 0 and 100, with higher numbers indicating a harder material, followed by the type of scale. For instance, a first material can be measured as having a Shore durometer of 40 Shore A and a second material can be measured as having a Shore durometer of 60 Shore D. Therefore, according to the Shore durometer scale, the second material is harder and thus, more stiff than the first material.

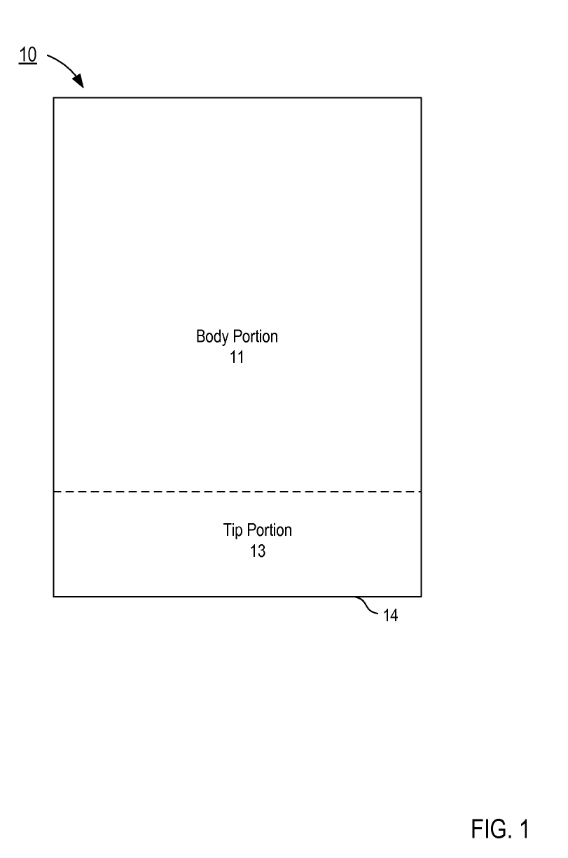

FIG. 1 is a schematic illustration of a stylus 10 according to an embodiment. The stylus 10 includes a body portion 11 and a tip portion 13. The stylus 10 can be used, for example, in conjunction with an electronic device (e.g., a personal computer (PC), a smart phone, a personal digital assistant (PDA), a tablet PC, and/or the like) having a touch screen (e.g., a capacitive touch screen or the like). The stylus 10 can be any suitable shape, size, or configuration. For example, in some embodiments, the body portion 11 of the stylus 10 can be a substantially elongate portion having a cross-sectional shape that is substantially polygonal (e.g., triangular, rectangular, square, hexagonal, pentagonal, etc.) or round (e.g., circular, oblong, elliptical, etc.). In some embodiments, the tip portion 13 can be a substantially tapered portion that extends from the body portion 11 and converges at a substantially rounded tip. Said another way, in some embodiments, the tip portion 13 can have a substantially parabolic cross-sectional shape having a substantially rounded local minimum. In some embodiments, the stylus 10 can have a shape that is substantially similar to that of a sharpened pencil or the like.

The stylus 10 can be formed from any suitable material or combination of materials. For example, in some embodiments, the body portion 11 and the tip portion 13 can be monolithically formed from a conductive flexible material such as, for example, conductive silicone or other conductive rubber. In other embodiments, the body portion 11 and the tip portion 13 can be independently formed and coupled together during manufacturing. For example, in some embodiments, the body portion 11 can be formed from a relatively stiff and/or relatively hard plastic and the tip portion 13 can be formed from a substantially flexible conductive silicone that is over-molded about a section of the body portion 11. As such, the body portion 11 can form a substantially rigid substrate about which at least a portion of the tip portion 13 can be disposed. In other embodiments, a stylus can include a tip portion formed from a substantially flexible conductive silicone and/or other conductive elastomeric material that is at least partially disposed within and coupled to a body portion (e.g., the body portion is at least partially hollow).

The tip portion 13 is configured to be placed in contact with a touch screen of an electronic device (also referred to herein as “touch sensitive display” or simply “touch screen”) to define at least a portion of an electric circuit. For example, as described above the tip portion 13 can be formed from a conductive silicone or the like that can complete an electric circuit when placed in contact with a touch screen. In some embodiments, the stylus 10 can be, for example, an active device. In such embodiments, the tip portion 13 can be operably coupled to a switch, a sensor or sensors (e.g., used as a switch), and/or the like configured to selectively close an electric circuit coupled thereto when the tip portion 13 is deformed (e.g., from being placed in contact with a touch screen). In other embodiments, a stylus can be, for example, a passive device that can include a metal rod or the like that is in physical and/or electrical contact with a tip portion.

As described above, in some instances, the touch screen or touch sensitive display can be a capacitive touch screen (e.g., a mutual capacitance touch screen or an absolute capacitance touch screen). Such a capacitive touch screens can be formed from a base insulator (e.g., glass) coated with a transparent conductor (e.g., indium tin oxide (ITO) or the like). Thus, when the conductive tip portion 13 of the stylus 10 is placed in contact with the touch screen, the electric circuit defined therebetween results in a distortion of an electrostatic field associated with the conductor of the touch screen. This distortion can, in turn, be measured as a change in capacitance associated with the conductor of the touch screen. More particularly, when the tip portion 13 of the stylus 10 is placed in contact with a mutual capacitance touch screen, the distortion of the electrostatic field alters a mutual coupling between one or more rows of electrodes and one or more columns of electrodes, which in turn, can be scanned to determine a change in capacitance therebetween. When the tip portion 13 of the stylus 10 is placed in contact with an absolute capacitance touch screen, the electric circuit defined therebetween can, for example, increase a load at a sensor and/or can increase a parasitic capacitance to a ground, which can be scanned to determine a change in capacitance. Thus, based on the change in capacitance of a portion of the touch screen, the electronic device can perform one or more actions, which can be, for example, graphically represented on the touch screen.

The tip portion 13 includes and/or can form an engagement surface 14. As described above, the tip portion 13 is formed from a substantially flexible conductive material such as silicone and/or rubber. As such, the tip portion 13 can have a hardness that is sufficiently small to allow the tip portion 13 to deform when placed in contact with a touch screen. In some embodiments, the tip portion 13 can be, for example, substantially hollow with a wall thickness that facilitates an elastic deformation of the tip portion 13. More specifically, when the tip portion 13 is placed in contact with the touch screen, the engagement surface 14 can be, for example, the deformed surface of the tip potion 13 that is placed in contact with the touch screen. Therefore, the size and/or shape of the engagement surface 14 can be based at least in part on the angle at which the stylus 10 is held relative to the touch screen, the amount of force applied to the stylus 10 (e.g., the amount of pressure applied by the tip portion 13 on the touch screen), the shape of the tip portion 13, the orientation of the stylus 10 relative to a user's hand, and/or the like. For example, in some embodiments, the stylus 10 can be substantially rectangular having a width that is larger than its thickness. In this manner, the engagement surface 14 formed when the width of the stylus 10 is aligned with a width of the touch screen can be substantially larger than when the thickness of the stylus 10 is aligned with the width of the touch screen. Moreover, in some instances, changing the size and/or shape of the engagement surface 14 can be operable in changing a capacitance of a corresponding portion of the touch screen (as described above) and thus, the electronic device can perform an action based on, for example, an arrangement of the engagement surface 14, as described in further detail herein.

In some instances, the tip portion 13 can be placed in contact with a touch screen with a substantially constant pressure and can be moved through a range of angles to change the size and/or shape of the engagement surface 14. For example, in some instances, the stylus 10 can be disposed substantially perpendicular to the touch screen to define a relatively small engagement surface 14 and can be tilted relative to the touch screen to define a larger engagement surface 14. In other words, when the tip portion 13 is placed in contact with the touch screen at a substantially constant pressure, the size of the engagement surface 14 can be increased by tilting the stylus 10 away from 90 degrees relative to the touch screen (e.g., transitioning the stylus 10 from a first configuration associated with a first size of the engagement surface 14 to a second configuration associated with a second size of the engagement surface greater than the first size). In some instances, the stylus 10 can be moved through a range of angles between, for example, 10 degrees and 170 degrees relative to a touch screen while maintaining the tip portion 13 in contact therewith. In other embodiments, the stylus 10 can be disposed at an angle that is smaller than 10 degrees or larger than 170 degrees while maintaining the tip portion 13 in contact with the touch screen. As such, the size of the engagement surface 14 is changed as the angle is brought toward the lower bound or the upper bound of the range of angles relative to the touch screen.

In other instances, the tip portion 13 can be placed in contact with the touch screen and held at a substantially constant angle relative to the touch screen and with a substantially constant orientation relative to a user's hand, and the user can increase a pressure between the tip portion 13 and the touch screen to increase the engagement surface 14. For example, as the pressure is increased, the deformation of the tip portion 13 is increased, thereby increasing the size of the engagement surface 14. In other words, an increase in the pressure can transition the stylus from a first configuration associated with the first size of the engagement surface 14 to a second configuration associated with a second size of the engagement surface 14. In some instances, an amount of deformation of the tip portion 13 can be proportional to a range of pressures exerted by the engagement surface 14 on the touch screen. For example, in some embodiments, a tip portion can be configured to register contact and/or the walls of the tip portion can be configured to deform when a pressure between the engagement surface and the touch screen is in the range of about 0.1 pounds per square inch (PSI) and 10 PSI. In other embodiments, a tip portion can be configured to register and/or to deform at a pressure that is less than 0.1 PSI. In still other embodiment, a tip portion can be configured to register and/or to deform at a pressure that is greater than 10 PSI.

In some instances, the electronic device can be configured to display a spot and/or line on the touch screen with a size or weight that substantially corresponds to the size of the engagement surface 14 (i.e., as a result of the completion of the electric circuit when the tip portion 13 is placed in contact with the touch screen). As such, the spot and/or line weight represented on the touch screen of the electronic device can be increased and/or decreased by changing the angle at which the stylus 10 is held relative to the touch screen, increasing or decreasing, respectively, the amount of force applied to the stylus 10, and or changing the orientation of the stylus 10 relative to the touch screen (e.g., aligning a width of the stylus 10 with the width of a touch screen or aligning a thickness of the stylus 10 with the width of the touch screen). In some embodiments, the electronic device can be configured to determine the angle of the stylus 10 relative to the touch screen based at least in part of the size and shape of the engagement surface 14 and the pressure applied by the engagement surface 14 on the touch screen.

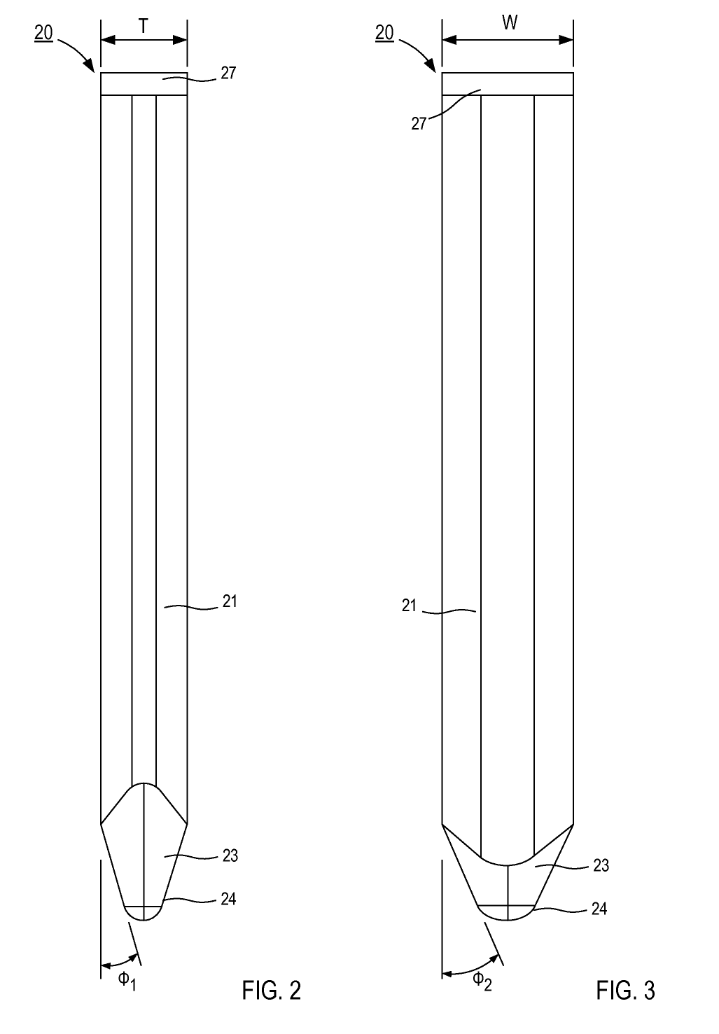

FIGS. 2-13 illustrate a stylus 20 according to an embodiment. The stylus 20 can be used, for example, in conjunction with an electronic device (e.g., a personal computer (PC), a smart phone, a personal digital assistant (PDA), a tablet PC, and/or the like) having a touch screen (e.g., a capacitive touch screen or the like). For example, the stylus 20 can be manipulated to place a conductive portion of the stylus 20 in contact with the touch screen (i.e., a touch sensitive display). The electronic device can, in turn, perform an action (e.g., execute a function, process, and/or module, at a processor, which is associated with a program, application, mobile application, etc.) based at least on part on the conductive portion of the stylus 20 being placed in contact with the touch screen.

The stylus 20 includes a body portion 21, a tip portion 23, and an end portion 27. The stylus 20 can be any suitable shape, size, or configuration. For example, in some embodiments, the body portion 21 of the stylus 20 can be a substantially elongate portion disposed between the tip portion 23 and the end portion 27. The body portion 21 can have a cross-sectional shape that is substantially polygonal (e.g., rectangular, pentagonal, hexagonal, etc.). In some embodiments, the body portion 21 can have substantially rounded corners that can, for example, enhance the ergonomics of the stylus 20. As shown in FIGS. 2 and 3, the stylus 20 has a thickness T and a width W. In some embodiments, the width W of the stylus 20 can be greater than the thickness T of the stylus 20. In this manner, a size, shape, and/or diameter of a surface of the tip portion 23 that is in contact with a touch screen of an electronic device can be varied by changing the orientation of the stylus 20, as described in further detail herein.

As described above with reference to the stylus 10 of FIG. 1, the stylus 20 can be formed from any suitable material or combination of materials. For example, in some embodiments, the body portion 21 and the tip portion 23 can be monolithically formed from a conductive flexible material such as, for example, conductive silicone or conductive rubber. In other embodiments, the body portion 21, the tip portion 23, and the end portion 27 can be formed independently and coupled together during manufacturing. For example, in some embodiments, the body portion 21 can be formed from a relatively stiff and/or relatively hard plastic while the tip portion 23 and the end portion 27 can be formed from a substantially flexible conductive silicone that is over-molded about a section of the body portion 21. As such, the body portion 21 can form a substantially rigid substrate about which at least a portion of the tip portion 23 and at least a portion of the end portion 27 can be disposed.

In other embodiments, a stylus can include a tip portion and/or an end portion formed from a substantially flexible conductive silicone and/or other conductive elastomeric material that is at least partially disposed within and coupled to a body portion (e.g., the body portion is at least partially hollow). In such embodiments, a section of the tip portion and/or a section of the end portion can be coupled to and/or at least temporarily maintained within the body portion via a press fit, a snap fit, a friction fit, a threaded coupling, and/or an adhesive. For example, in some embodiments, the tip portion can include a set of threads that can form a threaded coupling with a set of threads defined by an inner surface of the body portion. In this manner, a stylus can include a body portion that can be coupled to various tip portions and/or end portions having, for example, different sizes, shapes, and/or configurations.

As shown in FIGS. 2 and 3, the tip portion 23 extends from the body portion 21. More specifically, the tip portion 23 is substantially tapered, extending from the body portion 21 and converging at a rounded tip. In other words, the tip portion 23 can be substantially pyramidal (i.e., having a rectangular cross-sectional shape when taken about a plane that is perpendicular to the width W and the thickness T of the stylus 20) converging to a sphere or rounded tip. In other embodiments, a stylus can include a tip portion that can be substantially conical (i.e., having a circular cross-sectional shape when taken about a plane that is perpendicular to the width and the thickness of the stylus) that converges to a sphere or rounded tip. In still other embodiments, a stylus can include a tip portion that is substantially tapered, converging to a vertex (e.g., a substantially non-rounded tip).

In some embodiments, each surface of the tip portion 23 can extend from the body portion 21 at a substantially similar angle. In other embodiments, the surfaces of the tip portion 23 can extend from the body portion 21 at an angle that is substantially proportional and/or that relates to either the thickness T of the stylus 20 or the width W of the stylus 20. For example, as shown in FIG. 2, the tip portion 23 can include one or more surfaces that extend from the body portion 21 at a first angle Φ₁ that can be associated with the thickness T of the stylus 20 and one or more surfaces that extend from the body portion 21 at a second angle Φ₂, greater than the first angle Φ₁, that can be associated with the width W of the stylus 20. For example, in some embodiments, the first angle Φ₁ can be about 30 degrees and the second angle Φ₂ can be about 45 degrees. In other embodiments, a tip portion can have a first angle between about 5 degrees and about 30 degrees and a second angle between the value of the first angle and about 45 degrees. In still other embodiments, a tip portion can include a first angle that is greater than 30 degrees and a second angle between the value of the first angle and 90 degrees.

The tip portion 23 and the body portion 21 can form an intersection that can be, for example, non-linear. More specifically, as shown in FIGS. 2 and 3, the intersection of the tip portion 23 and the body portion 21 that relates to the thickness T of the stylus 20 can be concave (e.g., having a local minimum that extends away from the tip portion 23) and the intersection of the tip portion 23 and the body portion 21 that relates to the width W of the stylus 20 can be convex (e.g., having a local minimum that extends away from the body portion 21). In this manner, a surface of the tip portion 23 that relates to the thickness T of the stylus 20 extends beyond a surface of the tip portion 23 that relates to the width W of the stylus 20, as described in further detail herein.

As described above, the tip portion 23 is configured to be placed in contact with a touch screen of an electronic device to define at least a portion of an electric circuit. In some embodiments, the stylus 20 can be, for example, an active device. In such embodiments, the tip portion 23 can be operably coupled to a switch, a sensor or sensors (e.g., used as a switch), and/or the like configured to selectively close an electric circuit coupled thereto when the tip portion 23 is deformed (e.g., from being placed in contact with a touch screen). In other embodiments, a stylus can include a switch that can be, for example, a push button or the like that can be depressed by the thumb or finger of a user. In such embodiments, when a tip portion is placed in contact with the touch screen, the push button (e.g., the switch) can be depressed to complete the electric circuit. In still other embodiments, a stylus can be, for example, a passive device that can include a conducting member such as, for example, a metal rod, plate, and/or surface that can be placed in physical and/or electrical contact with a tip potion. By way of example, the tip portion can be placed in contact with the touch screen such that a surface of the tip portion deforms. The deformation of the surface of the tip portion can be such that an inner surface of the tip portion is brought into physical and/or electrical contact with the conducting member, thereby completing an electric circuit. Moreover, when the tip portion 23 of the stylus 20 is placed in contact with the touch screen (e.g., a capacitance touch screen), the tip portion 23 can distort an electrostatic field of a conductive portion of the touch screen, which in turn, can be scanned to determine a change in capacitance, as described in detail above. Thus, based on the change in capacitance of a portion of the touch screen, the electronic device can perform one or more actions, which can be, for example, graphically represented on the touch screen.

As described above, the tip portion 23 is formed from a substantially flexible conductive material such as silicone and/or any other suitable elastomeric material. The tip portion 23 can have a hardness that is sufficiently small to allow the tip portion 23 to deform when placed in contact with a touch screen. For example, in some embodiments, the tip portion 23 can have a durometer (e.g., hardness) between about 50 Shore A and about 70 Shore A. In other embodiments, the tip portion 23 can have a durometer that is less than 50 Shore A. In still other embodiments, the tip portion 23 can have a durometer that is greater than 70 Shore A. In some embodiments, the tip portion 23 can be, for example, substantially hollow with a wall thickness that facilitates an elastic deformation (i.e., non-permanent deformation) of the tip portion 23. For example, in some embodiments, the tip portion 23 can have a wall thickness between about 0.25 millimeters and about 1.00 millimeter. In other embodiments, the tip portion 23 can have a wall thickness that is less than 0.25 millimeters. In yet other embodiments, the tip portion 23 can have a wall thickness that is greater than 1.00 millimeter. As such, the combination of wall thickness of the tip portion 23 and the durometer of the material used to form the tip portion 23 can collectively determine the stiffness of the tip portion 23. In some embodiments, the wall thickness of the tip portion can be varied. For example, a stylus can include a tip portion with a wall thickness that increases as the tip portion extends from a body portion. Similarly stated, in some embodiments, the rounded end of a tip portion can have a greater wall thickness than a wall thickness of the tip portion at a position adjacent to the body portion. In other embodiments, a wall thickness of a side of a tip portion that relates to a width of a stylus can be different from a wall thickness of a side of the tip portion that relates to a thickness of a stylus, or vice versa.

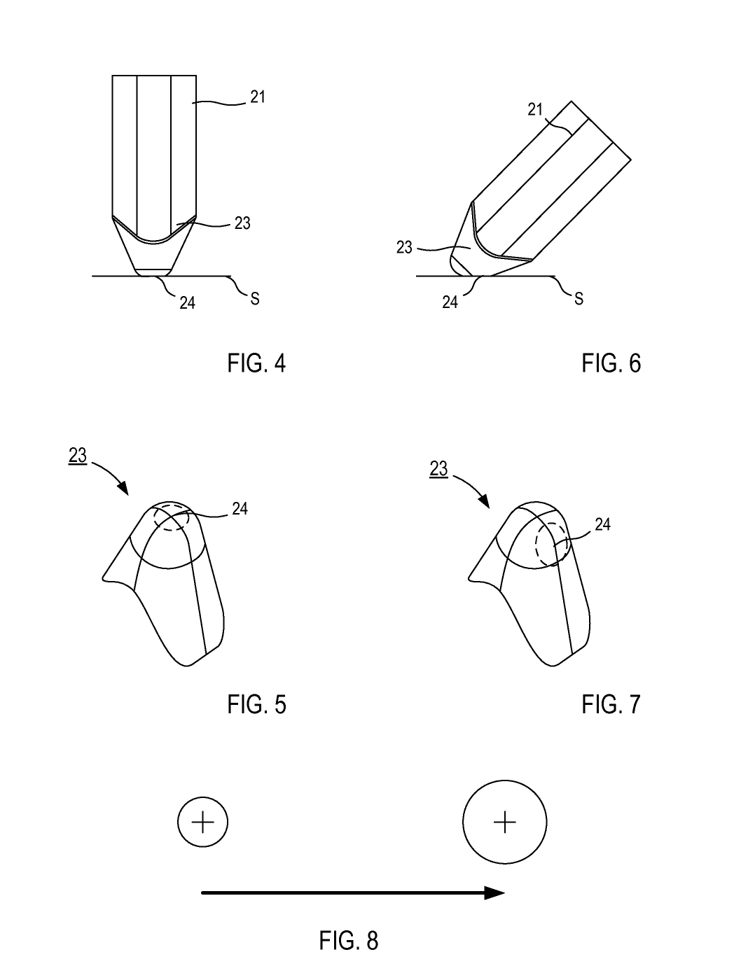

The tip portion 23 includes and/or can form an engagement surface 24. More specifically, when the tip portion 23 is placed in contact with the touch screen, the engagement surface 24 can be, for example, the deformed surface of the tip potion 23 that is placed in contact with the touch screen. Therefore, the size and/or shape of the engagement surface 24 can be based at least in part on the angle at which the stylus 20 is held relative to the touch screen, the amount of force applied to the stylus 20 (e.g., the amount of pressure applied by the tip portion 23 on the touch screen), the shape of the tip portion 23, the orientation of the stylus 20 relative to a user's hand, and/or the like. For example, as shown in FIGS. 4 and 5, when the stylus 20 is oriented substantially perpendicular to a surface S and the tip portion 23 is placed in contact therewith, the engagement surface 24 is formed at an end of the tip portion 23. Thus, with the tip portion 23 tapering to the rounded end, the diameter of the engagement surface 24 is relatively small. As described above, in some instances, the diameter of the engagement surface 24 can be increased by applying a larger force on the stylus 20. As such, the increase in force further deforms the tip portion 23, thereby increasing the diameter of the engagement surface 24. Said another way, the stylus 20 can be transitioned from a first configuration associated with a first size of the engagement surface 24 to a second configuration associated with a second size of the engagement surface 24 greater than the first size by increasing a force exerted on the stylus 20. In some embodiments, the wall thickness of the tip portion 23 can be sufficiently thick at the rounded end to allow a user to control the diameter of the engagement surface 24. Moreover, in some instances, changing the size and/or shape of the engagement surface 14 can be operable in changing a capacitance of a corresponding portion of the touch screen (as described above) and thus, the electronic device can perform an action based on, for example, an arrangement of the engagement surface 14, as described in further detail herein.

In other instances, a constant force can be applied to the stylus 20 and the angle of the stylus 20 relative to the surface S can be changed. For example, when the tip portion 23 is in contact with the surface S and the stylus 20 is at a non-normal angle relative to the surface S, the engagement surface 24 is formed on a side of the tip portion 23 rather than at the end, as shown in FIGS. 6 and 7. In this manner, with a similar force applied to the stylus 20, the area of the engagement surface 24 formed when the stylus 20 is disposed at an angle (e.g., other than 90°) relative to the surface S (e.g., when the stylus 20 is in a second configuration) is larger than the area of the engagement surface 24 formed when the stylus 20 is disposed substantially perpendicular (i.e., substantially 90°) to the surface S (e.g., when the stylus is in a first configuration). Moreover, when a constant force is applied to the stylus 20, the area of the engagement surface 24 is increased as the angle between the stylus 20 and the surface S is moved away from 90°, as shown in FIG. 8. For example, in some instances, the stylus 20 can be moved through a range of angles between, for example, 10 degrees and 170 degrees relative to a touch screen while maintaining the tip portion 23 in contact therewith. In other embodiments, the stylus 20 can be disposed at an angle that is smaller than 10 degrees or larger than 170 degrees while maintaining the tip portion 23 in contact with the touch screen. As such, the size of the engagement surface 24 is changed as the angle is brought toward the lower bound (e.g., toward 10 degrees) or the upper bound (e.g., toward 170 degrees) of the range of angles relative to the touch screen.

While the engagement surface 24 is described in the above example as being formed with a substantially constant force applied to the stylus 20, in other embodiments, the arrangement of the wall thickness of the tip portion 23 can be such that size of the engagement surface 24 increases as the stylus 20 is angled relative to the touch screen regardless of a decrease in the force applied to the stylus 20. For example, as described above, in some embodiments, a stylus can include a tip portion that has a wall thickness that is varied. In such embodiments, the wall thickness of the tip portion can be substantially thicker at the rounded end than at a position adjacent to a body portion of the stylus. As such, the stiffness of the tip portion can decrease from a first value at or around the rounded tip to a second value at or around the body portion. Thus, a smaller amount of force applied to the stylus when the stylus is disposed at an angle relative to the touch screen can result in a larger size of an engagement surface (FIGS. 6 and 7) than the size of an engagement surface formed when a larger force is applied to the stylus and the stylus is substantially perpendicular (FIGS. 4 and 5) to the touch screen.

Although the stylus 20 is shown in FIGS. 4-8 as being oriented such that a surface of the tip portion 23 that relates to the thickness T of the stylus 20 is in contact with the surface S (e.g., the width W of the stylus 20 is aligned with a length of the surface S), in other instances, a surface of the tip portion 23 that relates to the width of the stylus 20 can be in contact with the surface S. In this manner, the size of an engagement surface can be increased by moving the stylus 20 through a range of angles as described above. In some instances, when a substantially constant force is applied to the stylus 20 and when the stylus 20 is held at a substantially constant angle (e.g., other than 90 degrees), an engagement surface formed on a surface of the tip portion 23 that relates to the width W of the stylus 20 can be larger than an engagement surface 24 formed on a surface of the tip portion 23 that relates to the thickness T of the stylus 20.

In some instances, an electronic device can be configured to display a spot and/or line on a touch screen with a size or weight that substantially corresponds to the size of the engagement surface 24 (i.e., as a result of the completion of the electric circuit when the tip portion 23 is placed in contact with the touch screen). For example, when the tip portion 23 of the stylus 20 is placed in contact with the touch screen, the electronic device can be configured to determine (e.g., at a processor included therein) the relative position of the engagement surface 24, the pressure applied by the engagement surface 24 on the touch screen, the area of the engagement surface 24, the angle of the stylus 20 relative to the touch screen, and/or any other relevant information. Therefore, based at least in part on the determined information, the electronic device can be configured to send a signal to the touch screen indicative of an instruction to display a dot or line having a size or weight that corresponds to the engagement surface 24.

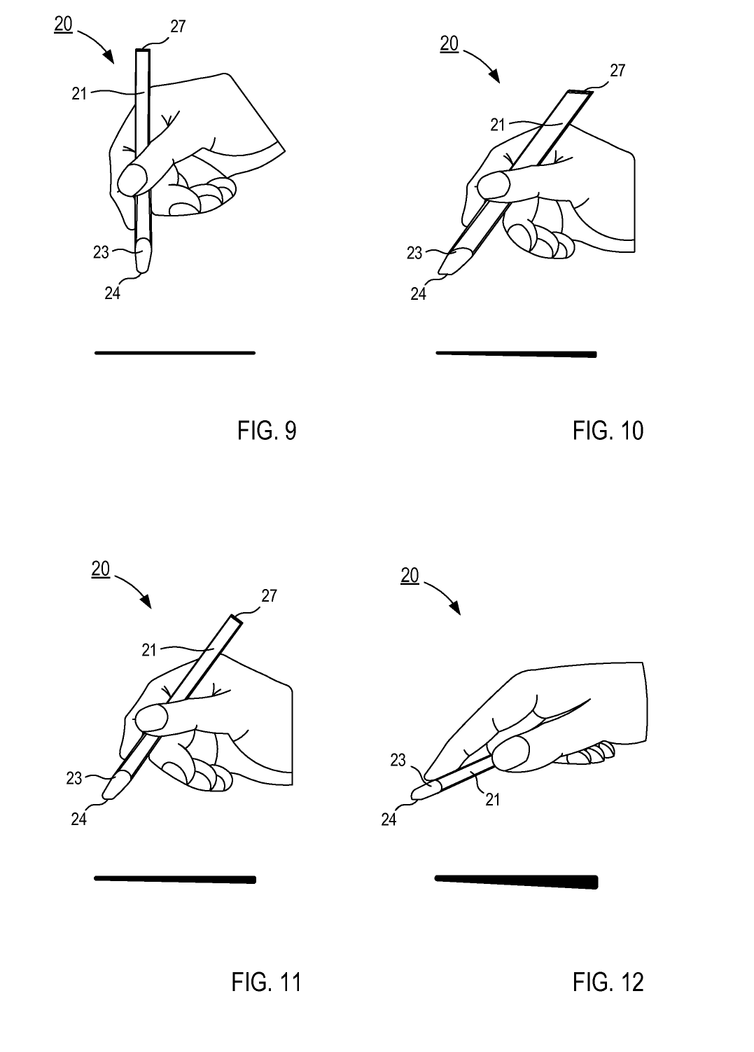

In some instances, the spot and/or line weight represented on the touch screen of the electronic device can be increased and/or decreased by changing the angle at which the stylus 20 is held relative to the touch screen, increasing or decreasing, respectively, the amount of force applied to the stylus 20, and or changing the orientation of the stylus 20 relative to the touch screen (e.g., aligning a width of the stylus 20 with the width of a touch screen or aligning a thickness of the stylus 20 with the width of the touch screen). For example, the electronic device can be configured to display a relative thin line when the tip portion 23 of the stylus 20 is placed in contact with the touch screen and the stylus 20 is held substantially perpendicular to the touch screen, as shown in FIG. 9. In some instances, the thickness of the line can be increased by changing the angle of the stylus 20 relative to the touch screen, as shown in FIG. 10. In some instances, the line thickness can be further increased by changing the orientation of the stylus 20 relative to a user's hand. For example, as shown in FIG. 11, a user can orient the stylus 20 such that the engagement surface 24 substantially corresponds to the width W (FIG. 3) of the stylus 20, as opposed to the thickness (FIG. 2) of the stylus 20. Moreover, the user can grasp the stylus 20 such that a relatively small angle is defined between the stylus 20 and the touch screen, thereby resulting in a relatively thick line, as shown in FIG. 12. In some instances, with the stylus 20 oriented as shown in FIG. 12, the arrangement of the engagement surface 24 can be such that the electronic device graphically represents, for example, a shading action on the touch screen (e.g., as opposed to graphically representing a line). Thus, a width of a line and/or an area of shading graphically represented on the touch screen as a result of contact between the touch screen and the engagement surface 24 substantially corresponds to a size, width, circumference, area, etc. of the engagement surface 24, which in turn, is dependent and/or otherwise associated with a force applied to the stylus 20 (e.g., by a user) and/or an angle of the stylus 20 relative to the touch screen. Furthermore, in some instances, a user can vary a force applied to the stylus 20 and/or vary the angle of the stylus 20 relative to the users hand and/or touch screen substantially concurrently with a movement of the engagement surface 24 along the touch screen. In other words, while the engagement surface 24 is moved along the touch screen, the user can vary a force applied to and/or an angle of the stylus 20 to, for example, vary a line thickness graphically represented on the touch screen in a corresponding manner.

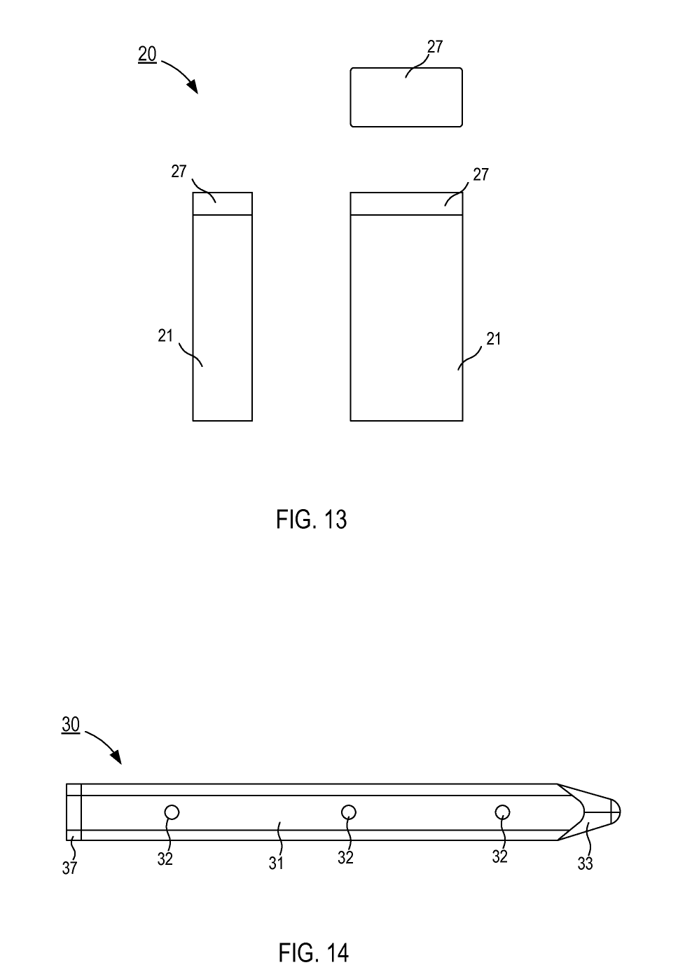

Referring now to FIG. 13, the end portion 27 of the stylus 20 extends from an end of the body portion 21 opposite the tip portion 23. The end portion 27 can be any suitable shape, size, or configuration. For example, the end portion 27 can have a size and shape that substantially corresponds to the body portion 21 of the stylus 20. Moreover, while the end portion 27 is shown in FIG. 13 as defining edges that are substantially linear (e.g., two orthogonal surfaces intersecting to define a substantially perpendicular corner), the end portion 27 can include substantially rounded corners, edges, and/or the like. As described above with reference to the tip portion 23, the end portion 27 can be formed from a relatively flexible conductive material such as, for example, conductive silicone. As such, the end portion 27 can be placed in contact with a touch screen to complete an electrical circuit (e.g., the stylus 20 can be transitioned from a first configuration or a second configuration, as described above, to a third configuration, in which the end portion 27 is placed in contact with the touch screen). In some embodiments, the end portion 27 can be operably coupled to a switch, a sensor(s), and/or a conducting member that can be operable in completing the electrical circuit, as described above.

In use, a user can manipulate the stylus 20 to place the end portion 27 in contact with a touch screen of an electronic device and the electronic device can, in turn, be configured to determine the relative location of the end portion 27. In some instances, based at least in part on a size and/or shape of an engagement surface (not shown in FIG. 13) of the end portion 27, the electronic device can determine that the end portion 27 (rather than the tip portion 23) is in contact with the touch screen. In some instances, the end portion 27 can be configured to transfer a voltage to the touch screen (e.g., the completion of the electrical circuit) that is substantially different from a voltage transferred by the tip portion 23 when the tip portion 23 is placed in contact with the touch screen. In such instances, electronic device can determine that the end portion 27 is in contact with the touch screen based at least in part on the voltage. Alternatively, the end portion 27 can transfer a voltage having a code or value to distinguish between the end portion 27 and the tip portion 23. In this manner, the stylus 20 can be manipulated to move the end portion 27 along the touch screen and, in some instances, the electronic device can, for example, delete, remove, undo, or otherwise erase a dot, line, or text represented on the touch screen. Said another way, the electronic device can perform (and graphically represent) a first action in response to the tip portion 23 being moved along a portion of the touch screen and the electronic device can perform (and graphically represent) a second action, substantially inverse to the first action, in response to the end portion 27 being moved along the portion of the touch screen. In other words, the end portion 27 can function substantially similar to an eraser of a pencil.

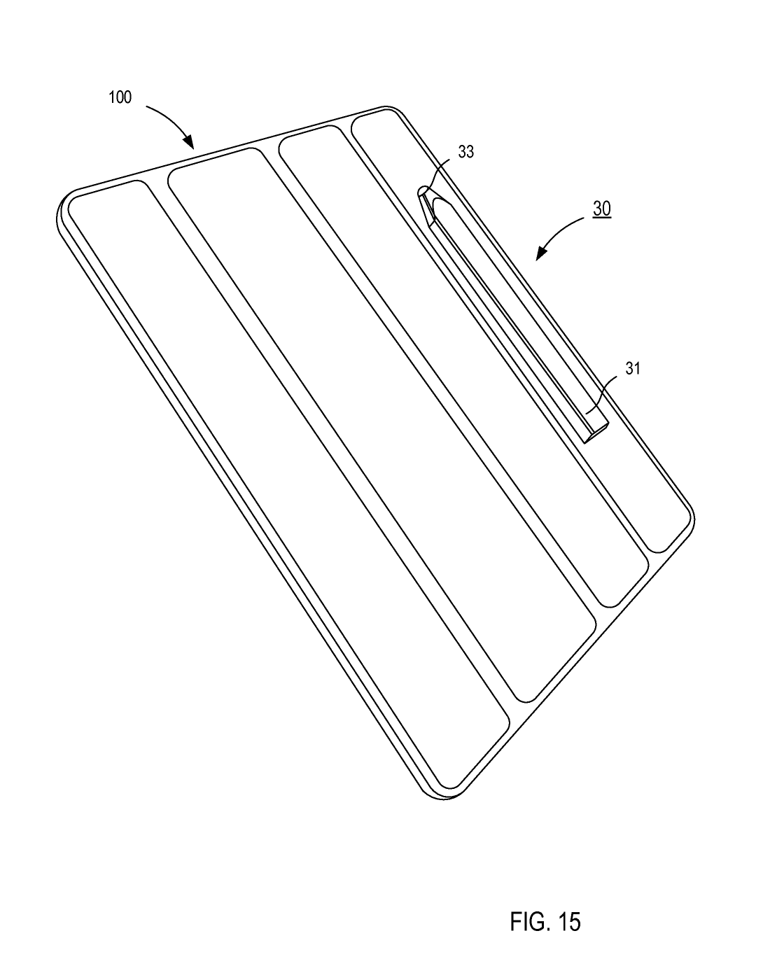

Although not shown in FIGS. 2-13, in some embodiments, a stylus can include any suitable retention member or the like that can at least temporarily couple the stylus to a portion of an electronic device. For example, FIGS. 14 and 15 illustrate a stylus 30 according to an embodiment. The stylus 30 includes a body portion 31, a tip portion 33, and an end portion 37. The stylus 30 can be substantially similar in form and function as the stylus 20 described above with reference to FIGS. 2-13. Therefore, aspects of the stylus 30 are not described in further detail herein and should be considered as substantially similar to or the same as the corresponding aspects of the stylus 20 unless explicitly expressed otherwise. The stylus 30 can differ from the stylus 20, however, with the addition of one or more retention members. For example, as shown in FIG. 14, the body portion 31 of the stylus 30 includes three retention members 32. In some embodiments, the retention members 32 can be, for example, magnets or the like. In this manner, the stylus 30 can be coupled to any suitable portion of an electronic device 100 and or cover operably coupled thereto, as shown in FIG. 15.

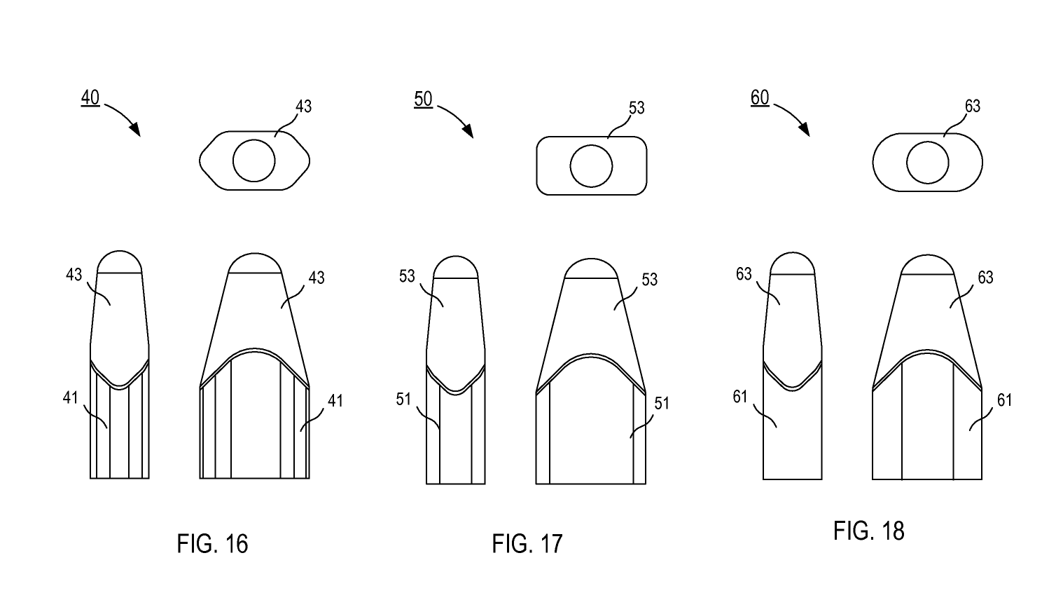

While various embodiments have been particularly shown and described above, it should be understood that they have been presented by way of example only, and not limitation. For example, while the stylus 20 is particularly described above with reference to FIGS. 2-13, in other embodiments, a stylus can have any suitable shape, size, or configuration. By way of example, FIG. 16 illustrates a stylus 40 having a body portion 41 and a tip portion 43, according to an embodiment. As shown, stylus 40 can have a substantially hexagonal cross-sectional shape and can function substantially similar to or the same as the stylus 20. As shown in FIG. 17, a stylus 50 can include a body portion 51 and a tip portion 53 and can have a substantially rectangular cross-sectional shape while functioning substantially similar to or the same as the stylus 20. As shown in FIG. 18, a stylus 60 can include a body portion 61 and a tip portion 63 and can have a substantially oblong or oval shape while functioning substantially similar to or the same as the stylus 20.

Where schematics and/or embodiments described above indicate certain components arranged in certain orientations or positions, the arrangement of components may be modified.

Although various embodiments have been described as having particular features and/or combinations of components, other embodiments are possible having a combination of any features and/or components from any of embodiments as discussed above. For example, any of the embodiments described herein can include an end portion that is substantially similar in form and function as the end portion 27 of the stylus 20 described above with reference to FIG. 13.

Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed:

1. An apparatus, comprising:
a stylus having
a body portion configured to be engaged by a user, the body portion defining a first cross-sectional area; and
a tip portion coupled to an end of the body portion, the tip portion having a first end and a second end, the first end disposed adjacent to the body portion and having the first cross-sectional area, the second end defining a second cross-sectional area different from the first cross-sectional area,
the tip portion being formed from a flexible material that elastically deforms when placed in contact with a touch sensitive display to define an engagement surface that is input to the touch sensitive display,
the engagement surface having a first size when the tip portion is placed in contact with the touch sensitive display and the stylus is in a first configuration, the engagement surface having a second size different from the first size when the tip portion is placed in contact with the touch sensitive display and the stylus is in a second configuration.

2. The apparatus of claim 1, wherein the flexible material of the tip portion is at least partially conductive, the stylus further having:
a conductive member at least partially disposed in the body portion, the conductive member being placed in contact with an inner surface of the tip portion when the tip portion is elastically deformed such that the conductive member and the tip portion complete an electric circuit associated with touch sensitive display.

3. The apparatus of claim 1, wherein the first cross-sectional area of the first end of the tip portion is greater than the second cross-sectional area of the second end of the tip portion, the tip portion defining a taper between the first end and the second end.

4. The apparatus of claim 1, wherein the stylus is in the first configuration when the stylus is in a first orientation relative to the touch sensitive display and the engagement surface exerts a first pressure on the touch sensitive display, the stylus being in the second configuration when the stylus is in a second orientation relative to the touch sensitive display and the engagement surface exerts a second pressure on the touch sensitive display, at least one of the second orientation or the second pressure being different from the first orientation or the first pressure, respectively.

5. The apparatus of claim 1, wherein an input to the touch sensitive display in response to the engagement surface results in an action being graphically represented on the touch sensitive display.

6. The apparatus of claim 1, wherein:
an input to the touch sensitive display in response to the engagement surface results in a first action being graphically represented on the touch sensitive display,
the end of the body portion is a first end and the engagement surface is a first engagement surface,
the stylus further having:
an end portion coupled to a second end of the body portion opposite the first end of the body portion, the end portion formed from a flexible material that elastically deforms when placed in contact with the touch sensitive display to define a second engagement surface that is input to the touch sensitive display,
an input to the touch sensitive display in response to the second engagement surface results in a second action being graphically represented on the touch sensitive display, the second action being substantially inverse to the first action.

7. The apparatus of claim 1, wherein an input to the touch sensitive display in response to the engagement surface results in a line being graphically represented on the touch sensitive display, a line weight of the line being associated with a size of the engagement surface.

8. An apparatus, comprising:
a stylus having
a body portion configured to be engaged by a user, the body portion having a first cross-sectional shape, the first cross-sectional shape having a thickness and a width different from the thickness; and
a tip portion coupled to an end of the body portion, the tip portion including a first end having the first cross-sectional shape and a second end having a second cross-sectional shape, the second cross-sectional shape having a size smaller than a size of the first cross-sectional shape, the tip portion including a first surface and a second surface extending between the first end and the second end, the first surface being associated with the thickness, the second surface being associated with the width,
the tip portion being formed from a flexible material configured to elastically deform when placed in contact with a touch sensitive display to define an engagement surface that is input to the touch sensitive display, the engagement surface having a first size when the first surface of the tip portion is placed in contact with the touch sensitive display, the engagement surface having a second size different from the first size when the second surface of the tip portion is placed in contact with the touch sensitive display.

9. The apparatus of claim 8, wherein the first cross-sectional shape is substantially polygonal and the second cross-sectional shape is substantially circular.

10. The apparatus of claim 8, wherein the width is greater than the thickness such that second size of the engagement surface is greater than the first size of the engagement surface.

11. The apparatus of claim 8, wherein the first surface extends from the body portion at a first angle and the second surface extends from the body portion at a second angle.

12. The apparatus of claim 8, wherein:
the first surface extends from the body portion at a first angle and the second surface extends from the body portion at a second angle,
the second angle is greater than the first angle.

13. The apparatus of claim 8, wherein the flexible material has a durometer between about 50 Shore A and about 70 Shore A.

14. The apparatus of claim 8, wherein the tip portion includes a set of walls having a thickness between about 0.25 millimeters and about 1.00 millimeters.

15. The apparatus of claim 8, wherein:
the tip portion includes a set of walls having a thickness between about 0.25 millimeters and about 1.00 millimeters,
the set of walls has a varied thickness between the first end of the tip portion and the second end of the tip portion, the first end of the tip portion associated with a first thickness and the second end of the tip portion associated with a second thickness greater than the first thickness.

16. A method, comprising:
deforming a tip portion of a stylus a first amount such that a first engagement surface of the tip portion is in contact with a touch sensitive display and that is input to the touch sensitive display, the first amount of deformation associated with the stylus in a first configuration, the first engagement surface having a first size associated with the stylus in the first configuration; and
deforming the tip portion of the stylus a second amount such that a second engagement surface of the tip portion is in contact with the touch sensitive display and that is input to the touch sensitive display, the second amount of deformation associated with the stylus in a second configuration different from the first configuration, the second engagement surface having a second size associated with the stylus in the second configuration, the second size being different from the first size.

17. The method of claim 16, wherein the first configuration is associated with a first pressure exerted by the first engagement surface on the touch sensitive display and the second configuration is associated with a second pressure exerted by the second engagement surface on the touch sensitive display, the second pressure being greater than the first pressure such that the second size is greater than the first size.

18. The method of claim 16, wherein the first configuration is associated with a first angle of the stylus relative to the touch sensitive display and the second configuration is associated with a second angle of the stylus relative to the touch sensitive display, the second angle being smaller than the first angle such that the second size is greater than the first size.

19. The method of claim 16, wherein the tip portion is formed from a flexible material that elastically deforms when in contact with the touch sensitive display.

20. The method of claim 16, wherein the stylus includes an end portion opposite the tip portion, the method further comprising:
deforming the end portion of the stylus when the stylus is in a third configuration such that an engagement surface of the end portion is in contact with the touch sensitive display and that is input to the touch sensitive display.
